(19) United States
(12) Patent Application Publication
(10) Pub. No.: US 2014/0345194 A1
(43) Pub. Date: Nov. 27, 2014

(54) TREE INJECTION SYSTEM

(71) Applicant: Rainbow Treecare Scientific Advancements, Inc., Minnetonka, MN (US)

(72) Inventors: Peter Vue, Brooklyn Park, MN (US); David L. Anderson, Champlin, MN (US); Gregory C. Krogstad, Monticello, MN (US); Joel C. Spies, Burnsville, MN (US); Christopher J. Haugen, Lake Elmo, MN (US); Shawn C. Bernick, Prescott, WI (US); Mark Kenneth Blodgett, East Bethel, MN (US); Michael James Hines, Minneapolis, MN (US); William Michael Roth, Minneapolis, MN (US); Mark William Schulz, Columbia Heights, MN (US); Daniel Darst, Zimmerman, MN (US)

(21) Appl. No.: 13/902,319

(22) Filed: May 24, 2013

(51) Int. Cl. A01G 7/06

(52) U.S. Cl. CPC A01G 7/06
USPC 47/57.5

(57) ABSTRACT

A tree injection system operates to deliver fluid chemistry to a tree. The tree injection system includes a tree injection device. The tree injection device includes an injection gun and a motorized fluidics system. Some embodiments further include a pod system that includes a pressurizable fluid container that receives fluid and pressurized air from the injection gun.

### BACKGROUND

Trees can be exposed to a variety of pathogens and nutrient deficiencies that can be controlled using fertilizers, insecticides, and fungicides. These treatments can be administered to the tree using a variety of methods including spraying the tree, applying a topical chemical, introducing the chemical in the soil, and/or injecting the tree itself. Injecting the tree is advantageous as it is a more direct method of administering such treatments, eliminating the potential for precipitation to wash away the chemical and ensuring that the tree receives the entire treatment. Additionally, tree injection treatments can be cost effective in the long term by reducing the amount of overall treatments required than, for example, a spray that washes off and must be reapplied.

Although injecting the tree can be more effective, tree injection devices can cause injury to trees by drilling larger holes than necessary into the tree, using a needle directly into the wood tissue, or injecting chemicals at high pressures which separate and terminate living cells. Current technology is powered manually or pneumatically. Manually powered devices can cause ergonomic injury as they require significant pressure while pneumatic systems deliver inconsistent and variable power with inaccurate delivery results.

### SUMMARY

In general terms, this disclosure is directed to an injection system. In one possible configuration and by non-limiting example, the injection system is a tree injection system. Various aspects are described in this disclosure, which include, but are not limited to, the following aspects.

One aspect is a tree injection device comprising: an electrical control system; a fluid delivery system, controlled by the electrical control system; an enclosure, wherein the electrical control system and the fluid delivery system are at least partially contained within the enclosure; a fluid container configured to store a fluid, and configured for fluid communication with the fluid delivery system; and an injection gun configured for fluid communication with the fluid delivery system.

Another aspect is a method of injecting fluid into a tree, the method comprising: retrieving a fluid from a fluid container using a motorized fluidics system; injecting a predetermined volume of the fluid into the tree using an injection gun.

A further aspect is a tree injection system comprising: a conduit delivery system; a fluid container configured to store a fluid and configured to be pressurized by a tree injection device, the fluid container comprising: an attachment mechanism for attaching the conduit delivery system; and a pressure release valve; and a stand for supporting the fluid container.

### BRIEF DESCRIPTION OF THE DRAWINGS

FIG. 1 is a perspective view of a system using a tree injection device in accordance with the principles of the present disclosure.

FIG. 2 is a perspective view of a tree injection device.

FIG. 3 is a top view of the tree injection device.

FIG. 4 is a cross-sectional view of a tree injection device.

FIG. 5 is a perspective view of an injection gun.

FIG. 6 is a rear view of an injection gun.

FIG. 7 is a cross-sectional view of an injection gun.

FIG. 8 is a front view of a fluid container.

FIG. 9 is a top view of a fluid container.

FIG. 10 is a perspective view of a tree injection device delivering fluid chemistry to a tree using an injection gun.

FIG. 11 is a perspective view of a tree injection device delivering fluid chemistry to a tree using a Pod system.

FIG. 12 is a schematic block diagram of the tree injection device.

FIG. 13 is a schematic block diagram of a fluidics system.

FIG. 14 is a flow chart showing an example method of injecting fluid chemistry into a tree using a tree injection device.

FIG. 15 is a flow chart showing an example method used by the fluidics system.

FIG. 16 is a flow chart showing an example method of injecting chemistry into a tree using the tree injection device and injection gun.

FIG. 17 is a flow chart showing an example method of injecting chemistry into a tree using the tree injection device and Pod system.

FIG. 18 is a perspective view of an injection gun delivering pressurized air to a fluid container. Capability

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. expectations

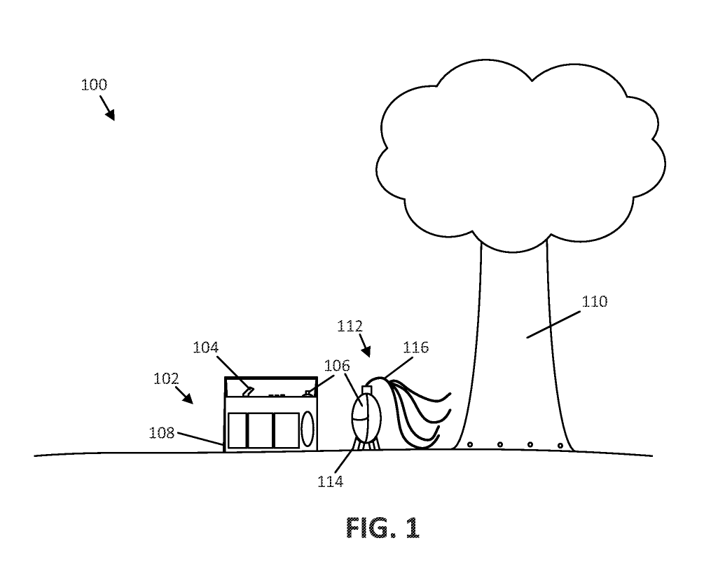

FIG. 1 is a perspective view of a tree injection system 100 including a tree injection device 102. In this example embodiment, the system 100 includes a tree injection device 102, including an injection gun 104 and a fluid container 106 housed inside an enclosure 108 that is placed near a tree 110. The tree injection device 102 in this example embodiment also includes a pod system 112 including a stand 114 holding a fluid container 106 that is attached to a conduit delivery system 116.

The tree injection device 102 is used to administer chemicals such as but not limited to fertilizers, insecticides, and fungicides to a tree 110. As described in further detail below, the tree injection device 102 includes an internal fluidics system that is used to deliver chemistry to the tree 110. The fluidics system is a motorized system that is controlled by internal electronics that receive user inputs and also monitor analytics such as, but not limited to the pressure and dosage of chemistry injected into the tree.

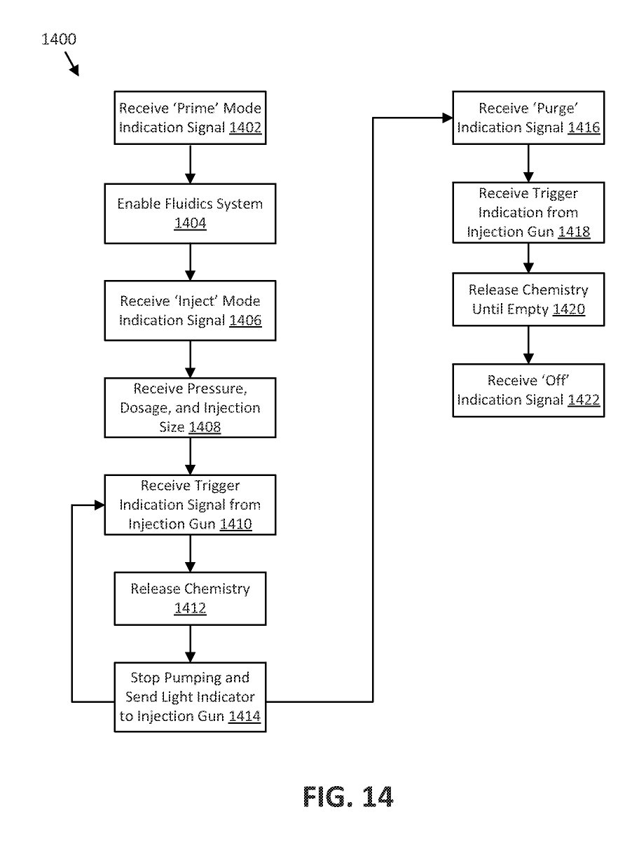

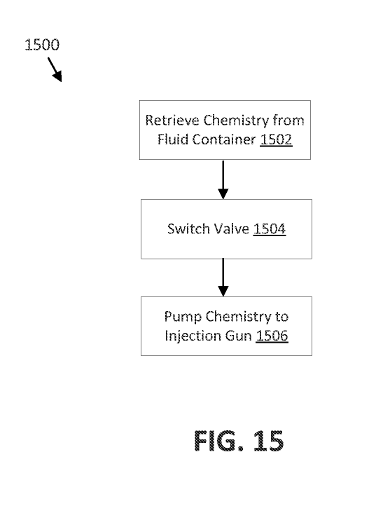

The tree injection device 102 offers several methods for injecting chemicals into a tree 110. One such method includes injecting a tree with chemicals using the injection gun 104, wherein the injection gun 104 is positioned in a hole drilled in the tree 110. In such an example, the fluidics system transfers chemistry from the fluid container 106 to the injection gun 104 and ultimately to the tree 110 using tubing (also referred to as a conduit system). This method is described in further detail with reference to FIGS. 14-15.

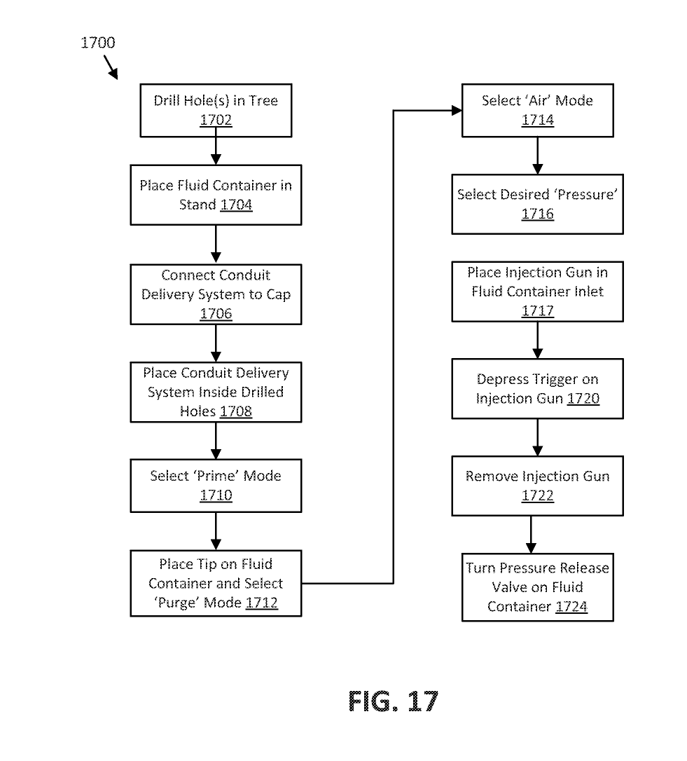

Another method for delivering chemicals into a tree 110 includes using a pod system 112 for delivering chemistry to the tree 110. In such an embodiment, the pod system 112 comprises, but is not limited to, a fluid container 106, a stand 114, at least one tip, and a conduit delivery system 116. In this example embodiment, the fluid container 106 is capable of being pressurized by the user. In operation, the injection gun 104, using the fluidics system, pressurizes the fluid container 106 to a pre-determined level. In this example, the conduit delivery system comprises a plurality of tubes that are positioned in holes drilled into the tree 110, while in other embodiments, the conduit delivery system comprises just one tube. In this embodiment, after pressurizing the fluid container 106, the user releases the pressure from the fluid container 106 by turning a pressure knob, thereby enabling chemistry to flow to the tree 110 at a constant, desired pressure. This method is described in further detail with reference to FIG. 17.

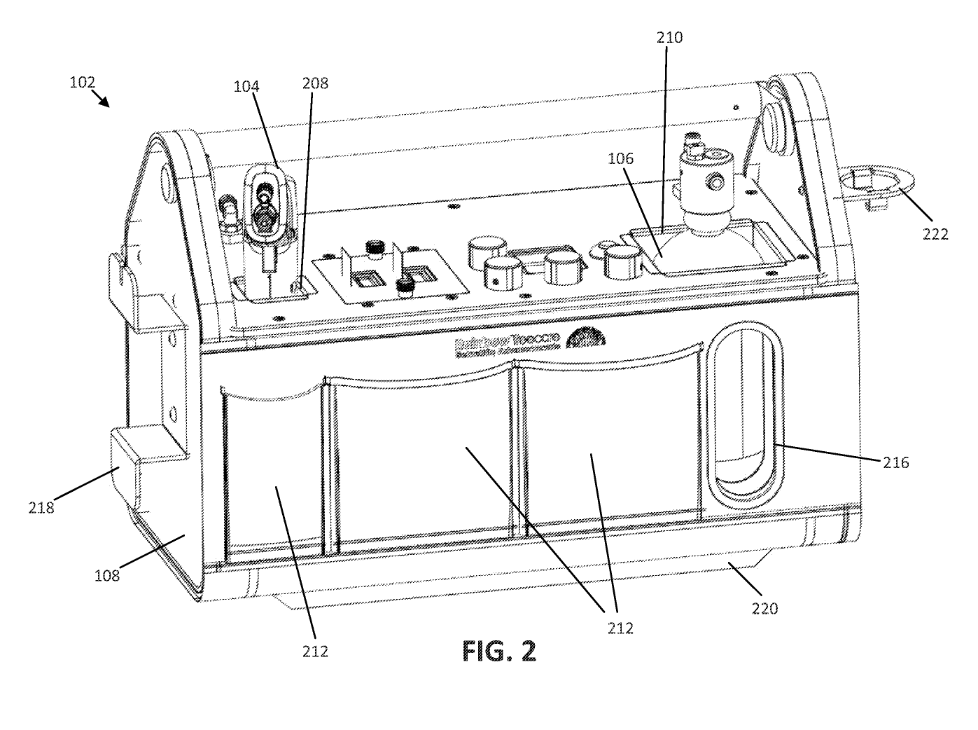

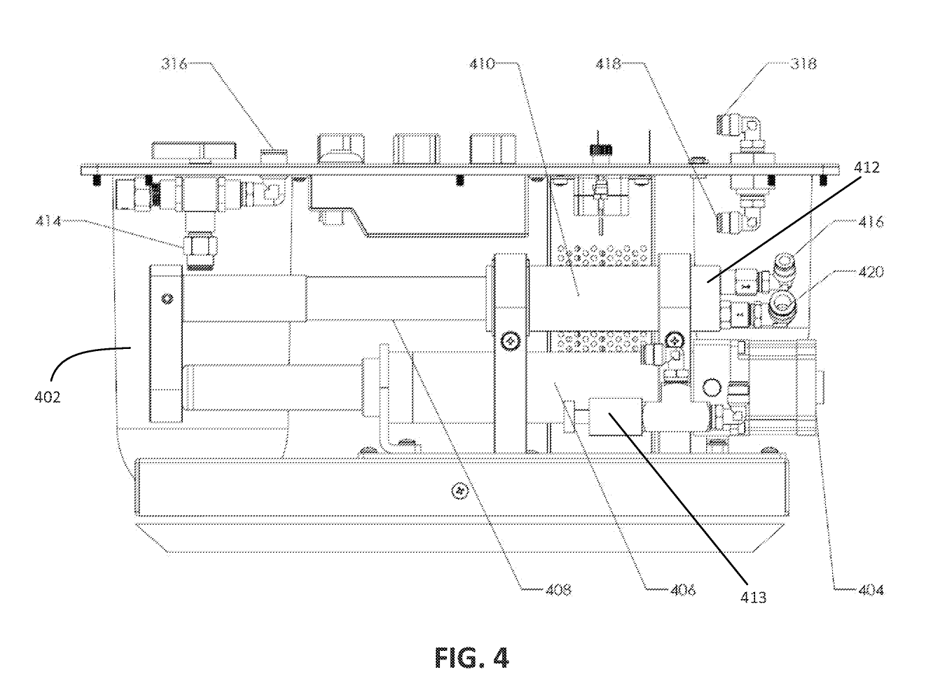

FIG. 2 is a perspective view of a tree injection device 102. In this example embodiment, the tree injection device 102 includes an enclosure 108 that houses an injection gun 104, a fluid container 106, and conduits (also referred to as tubing) that fluidly connect the injection gun 104, the internal motorized fluidics system (shown in FIG. 4), and the fluid container 106. Also included in the tree injection device 102 is user interface 204, batteries (not shown), a battery life display 206, and a motorized fluidics system located within the enclosure 108.

The enclosure 108 further defines a first opening 208 for housing the injection gun 104 and a second opening 210 for housing the fluid container 106. In this example embodiment, the enclosure 108 further includes pockets 212 lining the front side 214 to hold tools such as, but not limited to, a drill and drill bits. Additionally, the front side 214 of the enclosure 108 includes a window 216 revealing the fluid container 106. In some embodiments, the fluid container 106 is made of a transparent material, thus a view of the fluid chemistry within the fluid container 106 can be seen through the window 216. In this embodiment, the enclosure 108 further includes a reel 218 used to hold the conduits. In this embodiment, the enclosure 108 also includes a second handle 222 for an additional place to temporarily hold the injection gun 104, a cap for the fluid container 106, or additional tools.

The enclosure 108 also includes ridges 220 along the bottom part of the enclosure 108 that enable the enclosure 108 to sit off the ground and to shield the inside devices, such as the fluidics system and electrical components, from water damage. In some embodiments, the enclosure 108 is made of a mesh, plastic, or metal material that is water resistant. In other embodiments, nylon or other suitable materials are used.

In some embodiments, the tree injection device 102 further includes a rotatable handle 202 that can be locked in place, thus allowing a user to put weight on the device to aid in kneeling down and standing up.

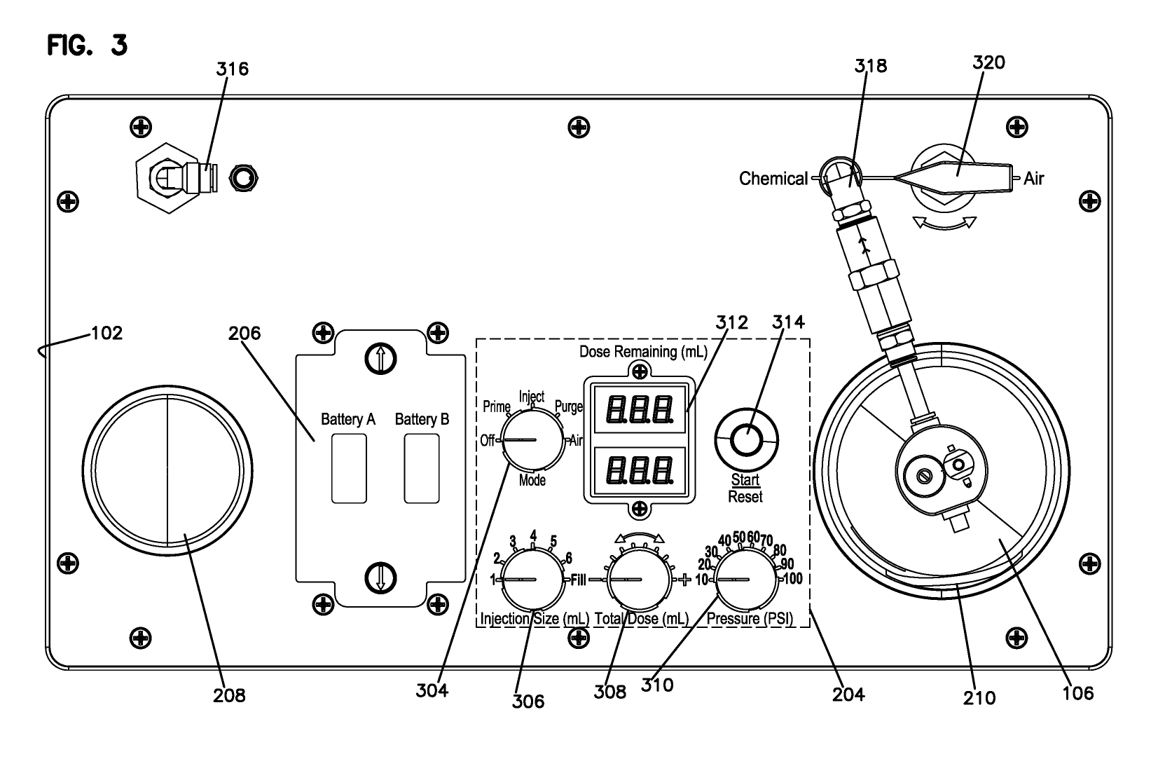

FIG. 3 is a top view of the tree injection device 102. As shown in this example embodiment and as described above, the tree injection device 102 includes a user interface 204 (as denoted by the dotted line), a first opening 208 for housing the injection gun 104 and a second opening 210 for housing the fluid container 106.

In this example embodiment, the user interface 204 includes a mode switch 304, an injection size selection knob 306, a total dose selection knob 308, a pressure selection knob 310 and a dosage display 312 that indicates how many doses of chemistry remain and how many doses of chemistry have been administered. In this embodiment, the user interface 204 also includes a start/reset button 314 for resetting the dosage display 312.

The tree injection device 102 also includes a battery life display 206 for each battery. As shown in this example, two batteries (Battery A and Battery B) are included. The battery life display measures the battery life of battery to indicate when to replace and/or recharge each battery. In other embodiments, other displays are included, such as a pressure display, indicating a current pressure reading that is being administered to the tree 110.

As shown in this embodiment, the enclosure 108 also includes a connector 316 for connecting the injection gun 104 to the internal fluidics system. The enclosure 108 also includes a connector 318 for connecting the fluid container 106 to the internal fluidics system. Also shown in this embodiment is an air valve 320 for manually disconnecting the connection between the fluid container 106 to the internal fluidics system.

FIG. 4 is a cross-sectional view of a tree injection device 102. In this embodiment, the tree injection device 102 includes a motorized fluidics system 402 electrically connected to control electronics, a power supply, and a conduit system. The fluidics system 402 includes a motor 404, a linear actuator 406, a piston system 408, a chamber barrel 410, and a manual ball valve 412. In this embodiment, the control electronics include, but are not limited to, a microprocessor, a quadrature encoder, motor drivers, and drivers that manage the electronic components of the tree injection device 102. In some embodiments, the control electronics control the user interface 204, the displays, and the fluidics system 402 such as the rate of fluid flow within the conduit system, and the pressure of the fluid flow.

As discussed above and shown in this example embodiment, the injection gun 104 is connected to the fluidics system 402 via the connector 316 that is located on the top side of the enclosure 108. The connector 316 is joined to another connector 414 located inside the enclosure 108. In operation, this connector 414 is connected to a first end of a conduit (not shown), wherein the second end of the conduit attaches to another connector 416 that is attached to the manual ball valve 412. Accordingly, the injection gun 104 (not shown) is connected to the fluidics system 402 via a conduit (not shown) and a plurality of connectors 316, 414, and 416.

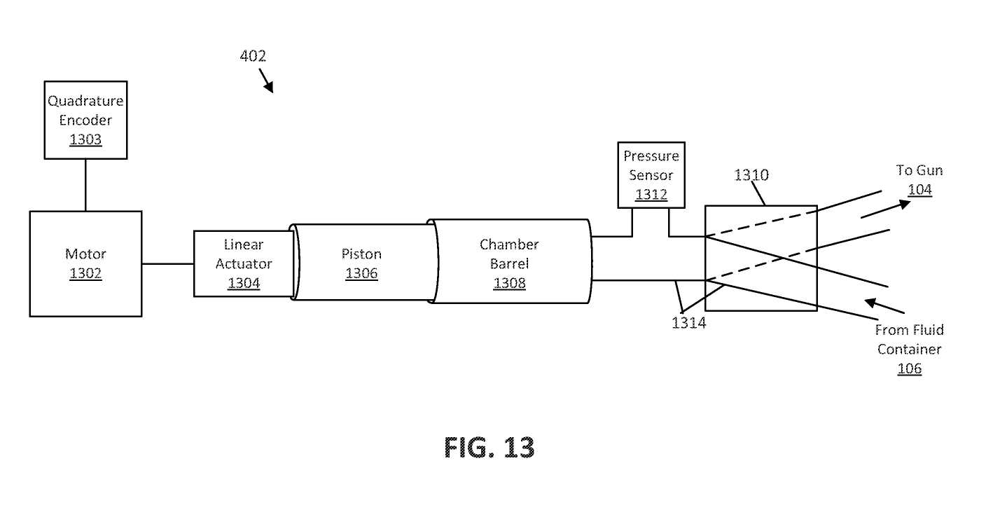

Similarly, the fluid container 106 is connected to the fluidics system 402 via the connector 318 that is located on the top side of the enclosure 108. The connector 318 is joined to another connector 418 located inside the enclosure. In operation, this connector 418 is connected to a first end of a conduit (not shown), wherein the second end of the conduit attaches to another connector 420 that is attached to the manual ball valve 412. Accordingly, the fluid container 106 (not shown) is connected to the fluidics system 402 via a conduit (not shown) and a plurality of connectors 318, 418, and 420. The fluidics system 402 is described in more detail in reference to FIG. 13.

In this embodiment, the pressure sensor 413 is used to measure the pressure of the fluid flowing therein. The pressure sensor 413 is powered by the power supply and is electrically connected to the microprocessor in the control electronics. The pressure sensor 413 determines the pressure of the fluid flow and sends a pressure signal to the microprocessor which uses the information to ensure the pressure remains below a specified pressure threshold by controlling the flow rate produced by the fluidics system 402.

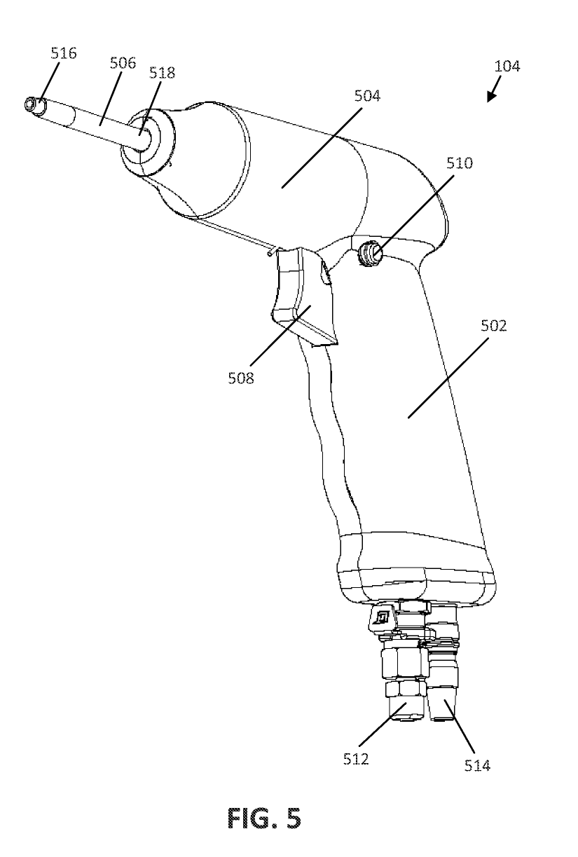

FIG. 5 is a perspective view of an injection gun 104. In this embodiment, the injection gun 104 includes a handle 502, a chamber 504, a nozzle 506, a trigger 508, and a safety mechanism 510. Additionally, this embodiment includes a first connector 512 for attaching a conduit (not shown) for receiving fluid chemistry from the fluidics system 402. This embodiment also includes a second connector 514 for attaching at least one electrical wire such as a copper wire (not shown) for connecting the internal gun electronics to the control electronics in the enclosure 108.

In this embodiment, the injection gun 104 receives fluid from a conduit (not shown) connected to the first connector 512 located at the end of the handle 502 and discharges the fluid from the tip 516 of the nozzle 506.

In this embodiment, the trigger 508 activates an electronic signal indicating that the injection gun 104 is properly placed within the tree 110 or within the fluid container 106 and ready for fluid delivery. In this embodiment, the term “fluid” refers to fluid chemistry or air. The trigger 508 also has a safety mechanism 510 that, when depressed, prevents the injection gun 104 from inadvertently triggering.

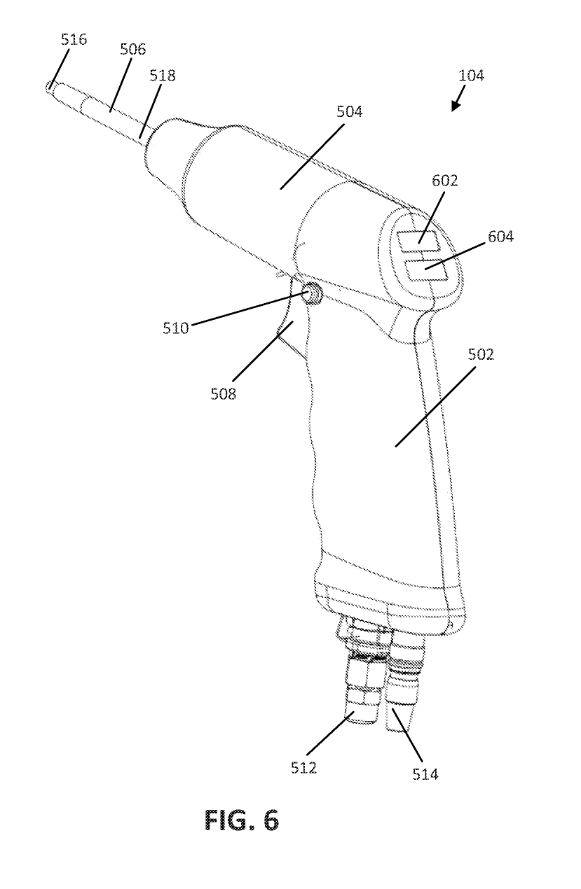

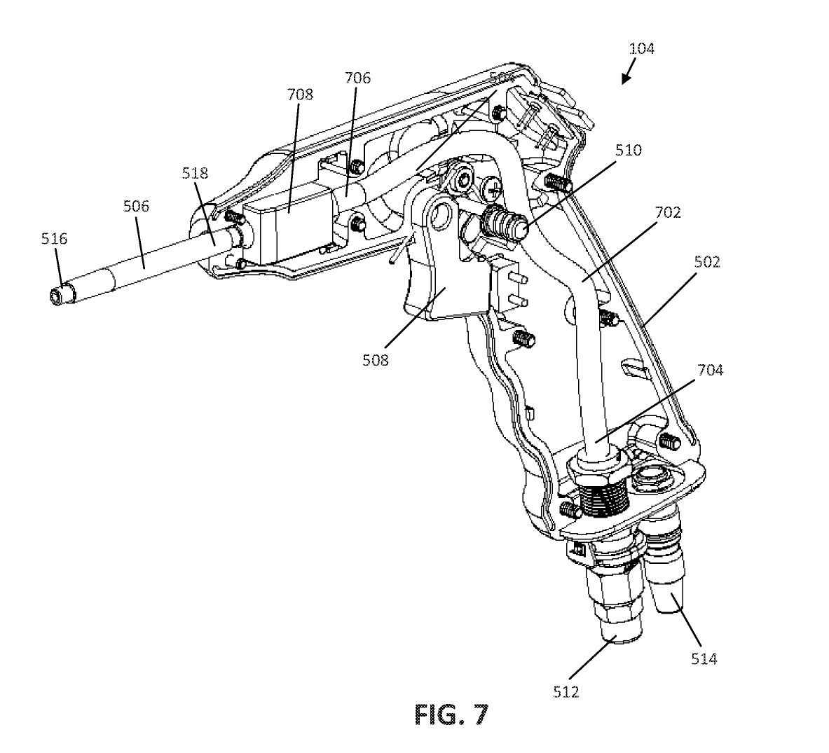

In this example embodiment, the cylindrical nozzle 506 extends outward from and parallel to the chamber 504 and gradually narrows toward a tip 516 such that the diameter of the base 518 is larger than the diameter of the tip 516. In some embodiments, the injection gun is used to pressurize the fluid container 106, thus the tip 516 is designed to be placed inside a fluid inlet of the fluid container 106. In other embodiments, the tip 516 is designed to be placed inside a hole drilled into the tree 110 and is used to inject the fluid chemistry therein. In some embodiments, one inch of the tip 516 fits inside the tree 110 and because of the taper, the tree 110 seals around the tip 516, thereby preventing any fluid chemistry from spraying out. The injection gun 104 is discussed in more detail in reference to FIGS. 6-7.

FIG. 6 is a rear view of an injection gun 104. In this embodiment, the injection gun 104 includes two light emitting diodes (LEDs) located on the back side of the chamber. In this embodiment, the first LED 602 indicates when a dosage is being delivered and the second LED 604 indicates when a dosage delivery is complete. In this example embodiment, when the first LED 602 is lit, it indicates that the tree injection device 102 is currently delivering a dose and it is therefore unsafe to remove the injection gun 104 from the tree 110. In this embodiment, when the second LED 604 is lit, it indicates that the tree injection device 102 completed delivery of a dosage and it is therefore safe to remove the injection gun 104 from the tree 110. In other embodiments, an alternative display can be used such as, but not limited to, a digital display that indicates when delivery is in progress and when delivery is complete. In other embodiments, a display is located on the enclosure 108 of the tree injection device 102.

FIG. 7 is a cross-sectional view of an injection gun 104. In this embodiment, the injection gun 104 includes a first connector 512 used for connecting a conduit to the injection gun 104 and a second connector 514 used for connecting an electrical wire to the injection gun 104. In this embodiment, the injection gun 104 contains a conduit 702 used to transfer fluid through the gun 104. As shown, the first end 704 of the conduit 702 is connected to the first connector 512 and the body of the conduit 702 is routed through the handle 502 and across the chamber 504. The second end 706 of the conduit 702 is connected to a manifold 708 that is located at the end of the chamber 504 and connected to the base 518 of the nozzle 506.

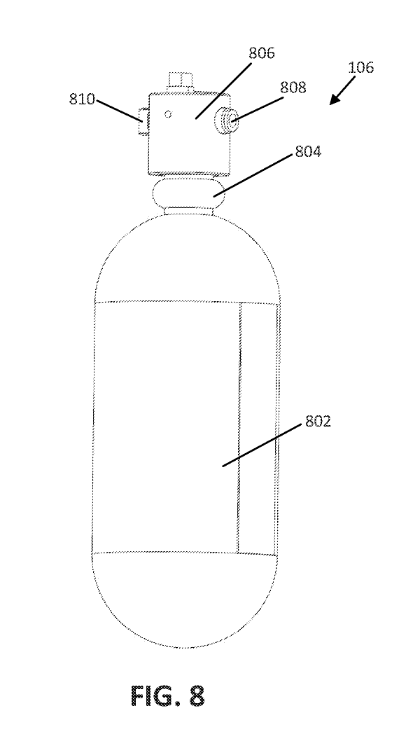

FIG. 8 is a front view of a fluid container 106. In this example embodiment, the fluid container 106 includes a rounded fluid receptacle 802 that extends upward to a neck 804 and is terminated by a cap 806. In this example embodiment, fluid chemistry resides in the fluid receptacle 802. In some embodiments, the fluid container 106 is comprised of a transparent material, thereby enabling a view of the level of liquid chemistry located therein. In other embodiments, the material is only partially transparent, such as a transparent window indicating the level of fluid chemistry located therein. The fluid container 106 is formed with any suitable material such as, but not limited to, glass, polymeric materials, composite materials, or metal.

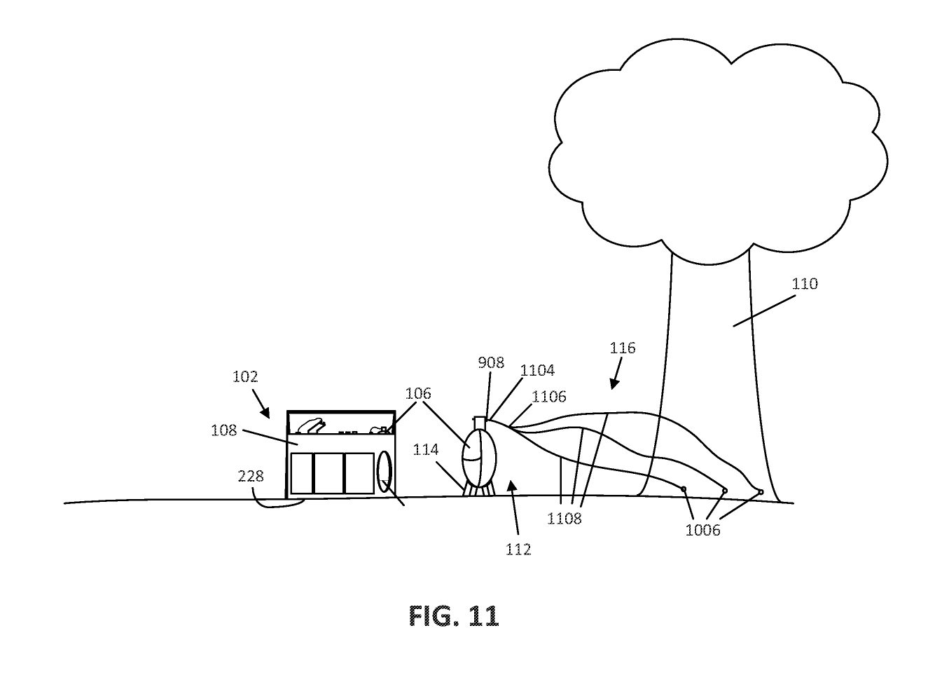

In this example embodiment, the fluid container 106 is capable of being pressurized, such as when it is used to administer fluid chemistry into the tree 110 using a pod system 112. In this embodiment, the cap 806 securely fastens to the neck 804 and is designed to keep a constant pressure inside the receptacle 802. The cap 806 contains an attachment mechanism 808 such as a threaded connector for attaching a conduit used for transporting the fluid chemistry to the fluidics system 402 or directly to the tree 110. The cap 806 also includes a pressure release valve 810 which is used to open a pathway to the conduits such that the fluid flows out of the bottle and through the pod system 112. The pod system 112 is described in more detail in reference to FIG. 11.

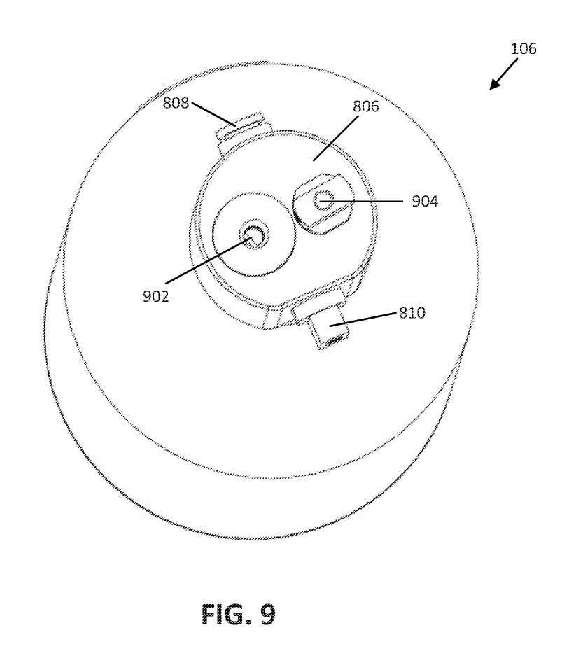

FIG. 9 is a top view of a fluid container 106. This embodiment shows the pressure release valve 810 and attachment mechanism 808 on the cap 806. This embodiment additionally shows an injection inlet 902 located on the top surface of the cap 806. The injection inlet 902 is used for injecting fluid chemistry or air into the fluid container 106 from the injection gun 104. Additionally shown in this embodiment is an air vent 904 located on the cap 806. In this embodiment, air exits the air vent 904. In other embodiments, the injection inlet 902, air vent 904, pressure release valve 810, and attachment mechanism 808 are located elsewhere on the fluid container 106.

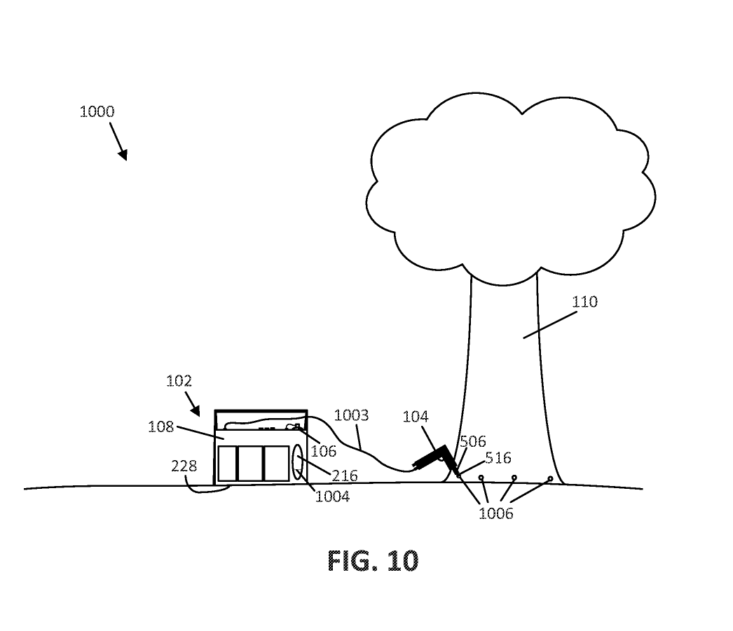

FIG. 10 is a perspective view of a system 1000 using a tree injection device 102 for delivering fluid chemistry to a tree 110 using an injection gun 104. In this example embodiment, the tree injection device 102 is placed on the ground near the tree 110. As described above, the bottom side 228 of the enclosure 108 includes ridges that allow the device 102 to sit off the ground to prevent the inside electronics from water or soil damage. In this example embodiment, the injection gun 104 is provided with fluid chemistry via a conduit 1003 connecting the injection gun 104 with the internal fluidics system 402 (not shown). In this embodiment, the fluid container 106 is placed inside the enclosure 108 of the tree injection device 102. Also shown in the embodiment is the window 216 in the enclosure 108 displaying the level 1004 of fluid chemistry in the fluid container 106.

In this embodiment, the tip 516 of the nozzle 506 is placed within a hole 1006 drilled into the tree 110. As shown in this embodiment, holes 1006 are drilled into the tree 110. Upon completing a dose, the tip 516 of the injection gun 104 is removed from the hole 1006. Fluid chemistry is thereafter delivered to each hole 1006 of the tree 110. In some embodiments, each hole 1006 receives the same dosage of fluid chemistry. In other embodiments, each hole 1006 receives a different dosage of fluid chemistry.

FIG. 11 is a perspective view of a tree injection device 102 delivering fluid chemistry to a tree 110 using a pod system 112. As described above, the pod system 112 comprises, but is not limited to, a fluid container 106, a stand 114, and a conduit delivery system 116. In this example embodiment, the tree injection device 102 and stand 114 holding a pressurized fluid container 106 are placed on the ground near the tree 110. In this example embodiment, a first end 1104 of a conduit delivery system 116 is connected to the attachment mechanism 908 of the fluid container 106 and the second end 1106 branches out into three conduits 1108. In this embodiment, each of the three conduits 1108 is inserted into a hole 1006 drilled in the tree 110. The method for injecting the tree 110 with fluid chemistry using the fluid container 106 and pod system 112 is described in more detail in reference to FIG. 17.

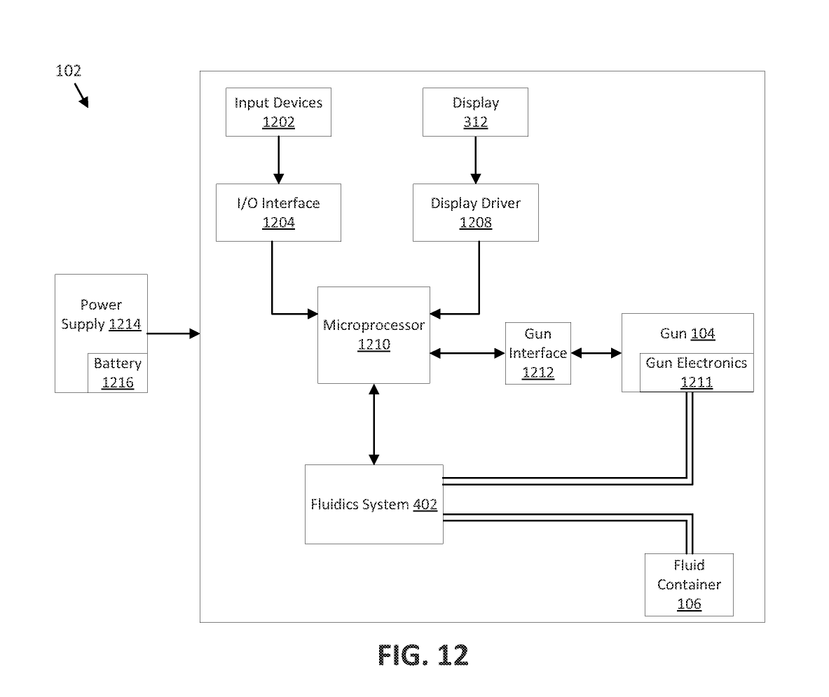

FIG. 12 is a schematic block diagram of the tree injection device 102. In this example embodiment, the tree injection device 102 includes input devices 1202 connected to an input/output interface 1204 and a display 312 connected to a display driver 1208 wherein the display driver 1208 and the input/output interface 1204 are electrically connected to a microprocessor 1210. Additionally in this example embodiment, an injection gun 104 further includes gun electronics 1211 wherein the gun electronics 1211 are connected to a gun interface 1212. In this embodiment, the gun interface 1212 is electrically connected to the microprocessor 1210. Additionally, electrical components of the fluidics system 402 are electrically connected to the microprocessor 1210. Also in this example embodiment, a fluid container 106 and the injection gun 104 are in fluid connection (denoted by the double line) with the fluidics system 402. In this embodiment, each electrical component is powered by an internal power supply 1214 receiving power from at least one battery 1216.

In this embodiment, the input devices 1202 are the inputs received from the user interface 204, as described in FIG. 2. These input devices 1202 include the interactive user elements such as the mode switch 304, an injection size selection knob 306, a total dose selection knob 308, a pressure selection knob 310, and a start/reset button 314. In other embodiments, other input devices are provided such as a valve switch knob. Among other capabilities, the input devices 1202 enable a user to set the desired dosage size for each injection, the desired pressure, and the total dosage of fluid chemistry delivered to the tree 110. The input devices 1202 are connected to an input/output interface 1204 that includes peripheral components such as resistors, capacitors, inductors, amplifiers, and other components recommended for the given microprocessor 1210. The microprocessor 1210 processes the signals received from the input devices 1202 and sends a corresponding signal to the fluidics system 402 indicating the selected dosage and pressure.

In this embodiment, electronics in the fluidics system 402 send a signal back to the microprocessor 1210 indicating the amount of doses injected into the tree 110. In this embodiment, the microprocessor 1210 calculates the total amount of fluid treatment to be injected into the tree 110 and the amount of fluid treatment remaining to be injected and sends a corresponding signal to the dosage display 312 located on the top side 302 of the enclosure 108 (shown in FIG. 3).

In this example embodiment, and as explained above, the injection gun 104 includes gun electronics 1211 such as, but not limited to a trigger control and LED controls. These gun electronics 1211 interface with the microprocessor 1210 through a gun interface 1212. In some embodiments, the gun interface 1212 includes peripheral components such as resistors, capacitors, inductors, and amplifiers. In this embodiment, the microprocessor 1210 receives a trigger indication signal from the gun electronics 1211 indicating when a user has depressed the trigger 508. In this embodiment, upon receiving the trigger indication signal, the microprocessor 1210 sends a corresponding signal instructing the fluidics system 402 to begin pumping fluid chemistry or air to the injection gun 104.

Additionally in this embodiment, the microprocessor 1210 sends a signal to the gun electronics 1211 to indicate when the delivery of a dosage is complete and when the delivery of a dosage is in progress. For example, in some embodiments, if the dosage delivery is in progress, the microprocessor 1210 instructs the gun electronics 1211 to flash a red LED, indicating to the user not to remove the injection gun 104 from the tree 110. In other embodiments, the microprocessor 1210 instructs the gun electronics 1211 to flash the green LED, indicating to the user it is safe to remove the injection gun 104 from the tree 110. In other embodiments, other indications are used such as a digital display located on the injection gun 104 or on the enclosure 108.

Additionally, the microprocessor 1210 receives a pressure signal from the pressure sensor 413 located in fluidics system 402. The microprocessor 1210 sends a corresponding signal to the dosage display 312, enclosure 108 of the tree injection device 102 to display the pressure during the dosage delivery.

In this example embodiment, the fluid container 106 and injection gun 104 are in fluid communication with the fluidics system 402. In this embodiment, the fluidics system 402 is responsible for pumping fluid chemistry from the fluid container 106 to the injection gun 104. In other embodiments, the fluidics system 402 pumps pressurized air to the injection gun 104 to pressurize the fluid container 106 of the pod system 112. In yet other embodiments, the fluidics system 402 is used to purge the fluid chemistry from the injection gun 104 back into the fluid container 106. The fluidics system 402 is described in more detail in reference to FIGS. 13 and 15.

FIG. 13 is a schematic block diagram of the fluidics system 402. In this embodiment, the fluidics system 402 includes a stepper motor 1302, a quadrature encoder 1303, a linear actuator 1304, a piston 1306, a chamber barrel 1308, a valve 1310, a pressure sensor 1312, and a plurality of fluid conduits 1314. In this embodiment, the quadrature encoder 1303 is electrically connected to the stepper motor 1302 and the microprocessor 1210. In this embodiment, the quadrature encoder 1303 outputs at least one digital signal, indicating a step, or a rotation, made by the motor 1302 and the direction of rotation. The motor 1302 then rotates the linear actuator 1304, causing the piston system 1306 to extend and depress. This movement by the piston system 1306 creates pressure and causes the fluid to flow from the fluid container 106 into the chamber barrel 1308. In other embodiments, air flows to the chamber barrel. In some embodiments, once the chamber barrel 1308 fills to a certain level with a fluid such as fluid chemistry from the fluid container 106 or air, the valve 1310 switches, allowing the fluid to flow from the chamber barrel 1308 to the injection gun 104. The process then continues and the fluid is directed to the injection gun 104 from the chamber barrel 1308.

Additionally in this embodiment, the pressure sensor 1312 determines the pressure of the fluid chemistry discharged to the injection gun 104 and ultimately into the tree 110. In this embodiment, the microprocessor 1210 receives the pressure reading from the pressure sensor 1312 to ensure the flow pressure remains below a specified pressure threshold.

FIG. 14 is a flow chart showing an example method 1400 of injecting fluid chemistry into a tree 110 used by a tree injection device 102. In this example embodiment, the method begins when the tree injection device 102 receives an indication that the mode is switched from ‘off’ to ‘prime’ (Step 1402). The prime mode prepares the tree injection device 102 for use. In some embodiments, the prime mode powers the electronic components and prepares the fluidics system 402 to pump fluid chemistry from the fluid container 106 to the injection gun 104. In other embodiments, the prime mode prepares the fluidics system 402 to pump air to the injection gun 104.

In this embodiment, after receiving the prime mode indication, the tree injection device 102 enables the fluidics system 402 (Step 1404). In this embodiment, enabling the fluidics system 402 involves powering the motor 1302 to pump fluid chemistry to the injection gun 104. In some embodiments, this involves pumping fluid chemistry from the fluid container 106 to the injection gun 104 through the conduit system. (Note that although fluid chemistry is used as an example, the fluidics system 402 is also designed to circulate air.). The fluidics system 402 is discussed in more detail in reference to FIG. 15.

Next, the tree injection device 102 receives an indication that the mode switched from ‘prime’ to ‘inject’ (Step 1406). In this example embodiment, when the tree injection device 102 receives an inject mode indication (Step 1406), the device prepares for pumping fluid chemistry or air through the injection gun 104. In some embodiments, receiving an inject mode indication (Step 1406) also prepares the tree injection device 102 to receive user inputs.

As noted above, the tree injection device 102 receives user inputs such as pressure, dosage, and injection size information from the input devices 1202 (Step 1408). These inputs direct the tree injection device 102 to accurately deliver a desired amount of fluid chemistry at a specified pressure to a receiving tree 110. In this embodiment, the microprocessor 1210 stores this information and displays dosage information on the display 312. As described in FIG. 12, the microprocessor 1210 thereafter transmits dosage, injection size, and total dosage information to the fluidics system 402.

In this embodiment, the microprocessor 1210 receives a trigger indication signal from the injection gun 104 (Step 1410). In this embodiment, the trigger indication signal directs the tree injection device 102 to release chemistry through the tip 516 of the nozzle 506 of the injection gun 104 (Step 1412). In some embodiments, the fluidics system 402 constantly measures the pressure of the chemistry discharged to the injection gun 104 and transmits this information to the microprocessor 1210. The microprocessor 1210 ensures the pressure remains below the specified pressure threshold by regulating the rate at which the fluidics system 402 pumps chemistry to the injection gun 104.

In this embodiment, once the dosage size is reached, the microprocessor 1210 instructs the fluidics system 402 to stop pumping chemistry. In some embodiments, when the pressure of the chemistry discharged into the hole 1006 drops, the microprocessor 1210 instructs the injection gun 104 to display the appropriate light indicator on the injection gun 104 (Step 1414) to indicate to the user that the injection gun 104 can be safely removed. Steps 1410-1414 are repeated until the desired total dosage is reached.

In this embodiment, once the total dosage is reached, the tree injection device 102 receives a purge indication signal (Step 1416). In this embodiment, the purge indication signal directs the tree injection device 102 to prepare the fluidics system 402 to empty the fluid remaining in the conduit system via the injection gun 104.

In this embodiment, the microprocessor 1210 receives a trigger indication signal from the injection gun 104 (Step 1418). Similar to Step 1410 above, the trigger indication signal directs the tree injection device 102 to release the excess chemistry within the conduit system through the injection gun 104 until the conduit system is empty (Step 1420). Finally, the tree injection device 102 receives an ‘off’ indication signal (Step 1422) which powers down all the active components within the system.

FIG. 15 is a flow chart showing an example method used by the fluidics system 402 as described in reference to FIGS. 13-14. This method describes enabling the fluidics system 402 (Step 1404) as discussed in reference to FIG. 14. In operation, enabling the fluidics system 402 (Step 1404) first requires retrieving chemistry from the fluid container 106 (Step 1502). In other embodiments, this the fluidics system 402 retrieves pressurized air. In this embodiment, the fluidics system 402 retrieves chemistry from the fluid container 106 by first switching the electronic valve 1310 to open a path for fluid to flow from the fluid container 106 to the chamber barrel 1308. The stepper motor 1302 then turns the linear actuator 1304 that then initiates the piston 1306. The piston 1306 then pumps fluid chemistry from the fluid container 106 to the chamber barrel 1308. Once the fluidics system 402 retrieves a desired amount of fluid chemistry from the fluid container 106, the valve 1310 is switched (Step 1504) such that the conduit system opens a path for the fluid to flow between the chamber barrel 1308 to the injection gun 104. The stepper motor 1302 then rotates the linear actuator 1304 that consequently triggers the piston 1306. The piston 1306 then pumps the fluid chemistry from the chamber barrel 1308 to the injection gun 104 (Step 1506). In some embodiments, the valve 1310 is a manual ball valve while in other embodiments the valve is an electronic valve.

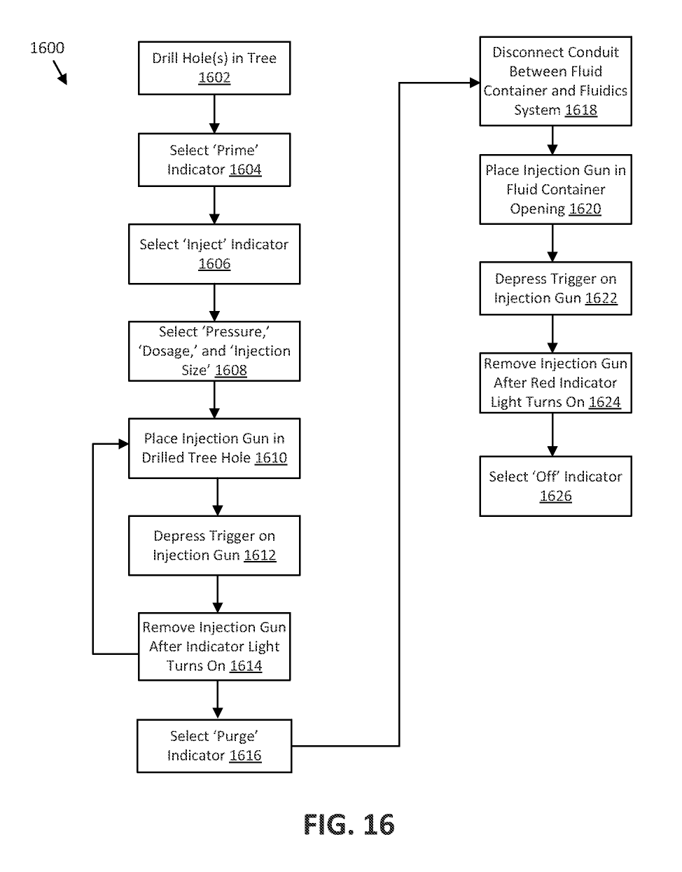

FIG. 16 is a flow chart showing an example method 1600 of injecting chemistry into a tree 110 using the tree injection device 102 and injection gun 104. In this embodiment, the user first drills at least one hole into the tree 110 (Step 1602). In some embodiments, the diameter of the hole is 15/64″ to ⅜″ with a depth in the range of about 0.5 inches to two inches. In other embodiments, other diameters and ranges are used as desired or necessary. In some embodiments the holes are spaced around the lower trunk of the tree 110.

In this embodiment, the user turns the mode switch to the ‘prime’ position to prepare it for injection into the tree 110 (Step 1604). In this embodiment, the user waits a short period of time and next selects the inject indicator switch (Step 1606) and selects a desired pressure, dosage, and injection size (Step 1608).

Next, the user places the tip 516 of the nozzle 506 of the injection gun 104 into a hole 1006 drilled into a tree 110 (Step 1610). Once the injection gun 104 is securely in place, the user then depresses the trigger on the injection gun 104 (Step 1612). In some embodiments, the user removes the injection gun 104 after an LED indicator 604, located on the injection gun 104, flashes on. In other embodiments, a display on the enclosure 108 indicates when a dosage is delivered. Steps 1610-1614 are repeated until the desired amount of dosage is reached.

In some embodiments, if fluid chemistry remains in the conduits, the user turns the mode switch to the ‘purge’ position (step 1616) and disconnects the conduit between the fluid container 106 (Step 1618) and the fluidics system 402 such that the system does not retrieve chemistry from the fluid container 106. In some embodiments, the user also switches an air valve 320 on the enclosure 108 to manually disconnect the connection between the fluid container 106 to the fluidics system 402. In some embodiments, the user thereafter places the tip 516 of the injection gun 104 into the fluid container 106 inlet 1002 (Step 1620). In other embodiments, the user places the injection gun 104 in another container such as a waste container. The user then depresses the trigger 508 on the injection gun 104 (Step 1622), which thereafter discharges the excess fluid chemistry from the conduits. After the conduits are drained, the user removes the injection gun 104 after the LED 604 indicator flashes on (Step 1624). In some embodiments, the user then turns the mode switch to the ‘off’ position (Step 1626).

FIG. 17 is a flow chart showing an example method 1700 of injecting chemistry into a tree 110 using the tree injection device 102 and pod system 112. In this embodiment, an empty fluid container 106 is filled and pressurized, which enables the fluid chemistry to flow from the fluid container 106 to the tree 110 using a conduit delivery system 116. In this embodiment, the user drills at least one hole 1006 into the tree 110 (Step 1702). In this embodiment, the user then places a fluid container 106 in a stand 114 (Step 1704) located on the ground near the tree 110 and connects the conduit system to the cap 806 (1706). As described with reference to FIG. 9, the conduit delivery system 116 is connected to the attachment mechanism 808 on the cap 806. Next, the user connects each of the conduits 1108 of the pod system 112 into each drilled hole 1006 (Step 1708).

Once the fluid container 106 and conduits 1108 of the pod system 112 are in place, the empty fluid container 106 is filled. The user turns the mode switch 304 to the ‘prime’ position (Step 1710). This step 1710 also involves depressing the trigger in order to fill the chamber barrel 1308 with fluid chemistry. Next, the user places the tip 516 of the injection gun 104 in the injection inlet 1002 and turns the mode switch 304 to the ‘purge’ position (Step 1712). Once the fluid container 106 is filled with fluid chemistry, the user then pressurizes the fluid container 106. (Note that if the fluid container 106 is already filled with chemistry, Steps 1710-1712 are skipped).

In order to pressurize the fluid container 106, the user first turns the mode switch 304 to the ‘air’ position. Next, the user selects a desired pressure (Step 1716). This pressure denotes the pressure at which the user wishes to pressurize the fluid container 106 and thus the pressure that will flow to the tree 110. The user then places the tip 516 of the nozzle 506 in the fluid container inlet 1002 (step 1718) and subsequently depresses the trigger 508 on the injection gun 104 (Step 1720). The fluidics system 402 then pressurizes the fluid container 106 to the selected pressure level. Once the fluid container 106 is pressurized to the selected level, the user removes the injection gun 104 (Step 1722). In some embodiments, the injection gun 104 indicates when the injection gun 104 can be removed using an LED indicator located on the injection gun 104. In other embodiments, another display is located on the injection gun 104, fluid container 106, or the enclosure 108 that indicates the fluid container 106 is properly pressurized. The user then turns the pressure release valve 910 on the fluid container 106 (Step 1724) which enables the fluid to flow from the fluid container 106 to the tree 110 through the conduits 1108.

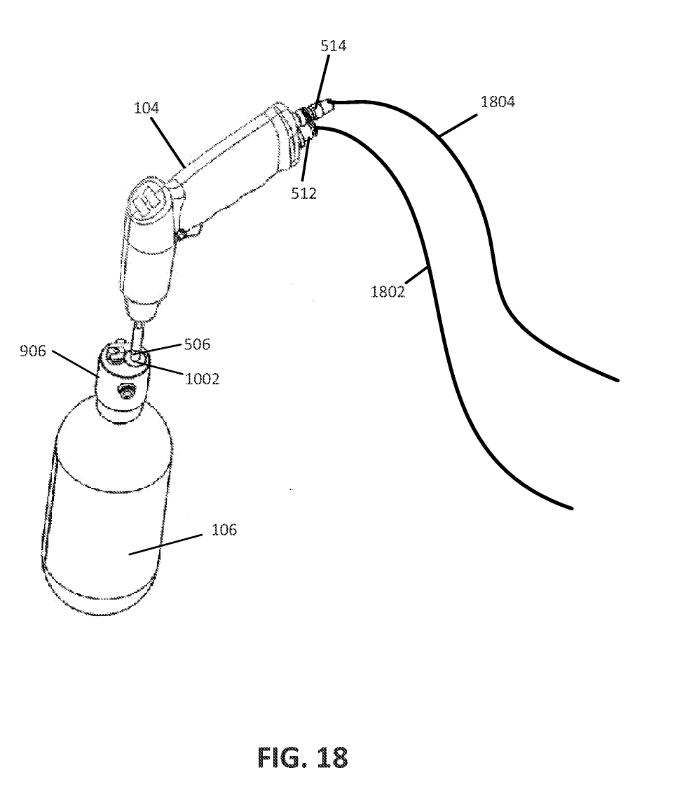

FIG. 18 is a perspective view of an injection gun delivering pressurized air to a fluid container, as described with reference to FIG. 17. This embodiment includes a fluid container 106 and an injection gun 104 wherein the injection gun 104 is pressurizing the fluid container 106 with air. As shown in this embodiment, the tip 516 (not shown) of the nozzle 506 is inserted in the injection inlet 1002 located on the top side of the cap 906. Additionally shown in this embodiment is the first connector 512 for attaching a conduit 1802 to the fluidics system 402 (not shown). Additionally, this embodiment includes a second connector 514 for attaching at least one electrical wire 1804 to the gun electronics 1211 (not shown). In this embodiment, the injection gun 104, powered by the gun electronics 1211, delivers pressurized air from the fluidics system 402, to the fluid container 106.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A tree injection device comprising:
an electrical control system;
a fluid delivery system, controlled by the electrical control system;
an enclosure, wherein the electrical control system and the fluid delivery system are at least partially contained within the enclosure;
a fluid container configured to store a fluid, and configured for fluid communication with the fluid delivery system; and
an injection gun configured for fluid communication with the fluid delivery system.

2. The device of claim 1 wherein the fluid delivery system further comprises:
a stepper motor;
a linear actuator in mechanical communication with the stepper motor;
at least one piston;
a chamber barrel for storing the fluid;
a pressure sensor for measuring a pressure of the fluid as it flows through the fluid delivery system; and
a valve.

3. The device of claim 1, wherein the device further comprises a power supply powered by at least one battery.

4. The device of claim 1, wherein the fluid delivery system is arranged and configured to deliver liquid chemical and air.

5. The device of claim 1, wherein the fluid container is arranged and configured to be pressurized by the injection gun.

6. The device of claim 1 wherein the injection gun is arranged and configured to return the fluid back into the fluid container.

7. The device of claim 1, wherein the injection gun further comprises:
a nozzle; and
a tip connected to the nozzle, wherein the tip is arranged and configured to inject directly into a tree.

8. The device of claim 2, wherein the valve is a manual ball valve.

9. The fluid container of claim 1, further comprising:
a receptacle for storing the fluid;
a neck that extends up from the receptacle; and
a cap that is fastened to the neck.

10. The fluid container of claim 9, wherein the neck further comprises:
an attachment mechanism for receiving a first conduit; and
an injection inlet for receiving fluid from the injection gun.

11. A method of injecting fluid into a tree, the method comprising:
retrieving a fluid from a fluid container using a motorized fluidics system; and
injecting a predetermined volume of the fluid into the tree using an injection gun.

12. The method of claim 11 further comprising receiving pressure, dosage, and injection size inputs from a user interface of a tree injection device.

13. The method of claim 11 further comprising:
measuring pressure of a fluid flow of the fluid; and
notifying a user when it is safe to remove the injection gun from the tree.

14. The method of claim 11 further comprising:
displaying a total dose of fluid injected into the tree; and
displaying a total dose of fluid remaining

15. The method of claim 11 wherein retrieving a fluid from a fluid container further comprises:
switching a valve to open a pathway for the fluid to flow from the fluid container to the motorized fluidics system;
rotating a linear actuator using a motor;
reciprocating a piston to pump fluid from the fluid container through the pathway; and
filling a chamber barrel with the fluid.

16. The method of claim 11, wherein injecting the predetermined volume of the fluid into the tree comprises injecting without exceeding a specified pressure threshold.

17. The method of claim 11, wherein injecting the predetermined volume of the fluid into the tree occurs after activation of a trigger of the injection gun.

18. A tree injection system comprising:
a conduit delivery system;
a fluid container configured to store a fluid and configured to be pressurized by a tree injection device, the fluid container comprising:
an attachment mechanism for attaching the conduit delivery system; and
a pressure release valve; and
a stand for supporting the fluid container.

19. The tree injection device of claim 18, wherein the fluid container further comprises a cap comprising:
an injection inlet allowing the container to be filled with fluid or pressurized; and
the pressure release valve.
